(19) United States
(12) Patent Application Publication
(10) Pub. No.: US 2021/0227081 A1
(43) Pub. Date: Jul. 22, 2021

(54) INFORMATION PROCESSING APPARATUS THAT CREATES PROCESSED TEXT DATA FROM TEXT DATA, BY CHANGING ORDER OF SENTENCES IN TEXT DATA, AND IMAGE FORMING APPARATUS

(71) Applicant: KYOCERA Document Solutions Inc., Osaka (JP)

(72) Inventors: Dennis ARRIOLA, Osaka (JP); Rowel ORBANEJA, Osaka (JP)

(73) Assignee: KYOCERA Document Solutions Inc., Osaka (JP)

(21) Appl. No.: 17/142,991

(22) Filed: Jan. 6, 2021

(30) Foreign Application Priority Data
Jan. 16, 2020 (JP) 2020-005402

(51) Int. Cl. H04N 1/00; G06F 40/131; G06F 40/106; G06F 40/258; G06K 9/00

(52) U.S. Cl. CPC H04N 1/00331; G06F 40/131; G06K 9/00422; G06F 40/258; G06K 9/00469; G06F 40/106

(57) ABSTRACT

An information processing apparatus includes an image reading device, and a control device that acts as a text converter, a divider, an extractor, and a text processor. The text converter converts a source image acquired by the image reading device from the source document, into text data. The divider divides the text data converted by the text converter into a plurality of text groups, using a predetermined criterion. The extractor extracts, from the plurality of text groups divided by the divider, a key text group containing a specific word identified by a predetermined rule, among words contained in the text data constituting the plurality of text groups. The text processor creates processed text data by placing the key text group at a head position, and placing remaining text groups other than the key text group in the plurality of text groups, at a position subsequent to the key text group.

### INCORPORATION BY REFERENCE

This application claims priority to Japanese Patent Application No. 2020-005402 filed on 16 Jan. 2020, the entire contents of which are incorporated by reference herein.

### BACKGROUND

The present disclosure relates to an information processing apparatus and an image forming apparatus, and in particular to a technique to process an image read from a source document into text data.

Information processing apparatuses are configured to read a source document with a scanner or the like, and convert the acquired source image into text data, by optical character recognition (OCR). In this relation, for example, a technique has been developed to output the text data converted as above, in a layout according to that of the source document. Another technique has been developed to convert a source image acquired by reading a source document containing characters that include hand-written characters, and then modify the character pattern with respect to the portion converted to text data from the hand-written characters.

### SUMMARY

The disclosure proposes further improvement of the foregoing technique.

In an aspect, the disclosure provides an information processing apparatus including an image reading device, and a control device. The image reading device reads an image of a source document. The control device includes a processor and acts as a text converter, a divider, an extractor, and a text processor, when the processor executes a control program. The text converter converts a source image acquired by the image reading device through reading of the source document, into text data. The divider divides the text data converted by the text converter into a plurality of text groups, using a predetermined criterion. The extractor extracts, from the plurality of text groups divided by the divider, a key text group containing a specific word identified by a predetermined rule, among words contained in the text data constituting the plurality of text groups. The text processor creates processed text data by placing the key text group at a head position, and placing remaining text groups other than the key text group in the plurality of text groups, at a position subsequent to the key text group.

In another aspect, the disclosure provides an image forming apparatus including the foregoing information processing apparatus, and an image forming device. The image forming device forms an image representing the processed text data on a recording medium.

### BRIEF DESCRIPTION OF THE DRAWINGS

FIG. 1 is a front cross-sectional view showing a configuration of an image forming apparatus, exemplifying an information processing apparatus according to the disclosure;

FIG. 2 is a functional block diagram showing an essential internal configuration of the image forming apparatus;

FIG. 3 is a flowchart showing a data processing operation;

FIG. 4 is a schematic drawing showing an example of an operation screen displayed on a display device;

FIG. 5 is a schematic drawing showing an example of a hand-written source document;

FIG. 6 is a flowchart showing a text processing operation;

FIG. 7 is a schematic drawing showing an example of text data generated through conversion by a text converter;

FIG. 8A is a schematic drawing showing examples of divided text groups;

FIG. 8B and FIG. 8C are schematic drawings showing how a key text group and a remaining text group are created;

FIG. 9 is a schematic drawing showing text data including the extracted key text group and the remaining text group;

FIG. 10 is a schematic drawing showing text data in which the key text group and the remaining text group are combined;

FIG. 11 is a schematic drawing showing an example of processed text data created through data processing;

FIG. 12 is a flowchart showing an editing process constituting a part of the data processing;

FIG. 13 is a schematic drawing showing an example of an operation performed on a screen of the display device;

FIG. 14 is a schematic drawing showing another example of the operation performed on the screen of the display device;

FIG. 15 is a schematic drawing showing an example of the operation performed on the screen of the display device, and a resultant display; and

FIG. 16 is a schematic drawing showing an example of text data subjected to the data processing and the editing process.

### DETAILED DESCRIPTION

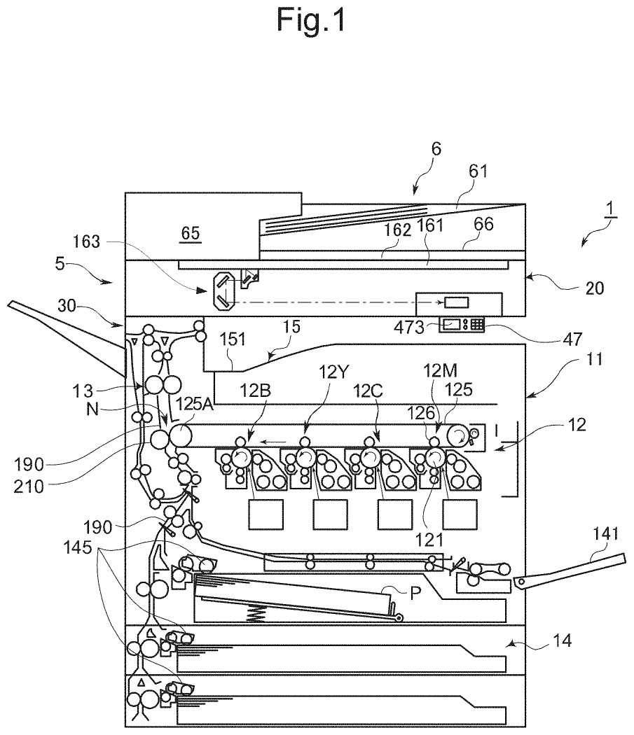

Hereafter, an information processing apparatus and an image forming apparatus according to the disclosure will be described, with reference to the drawings. FIG. 1 is a front cross-sectional view showing a configuration of the image forming apparatus, exemplifying the information processing apparatus according to the disclosure. The image forming apparatus 1 is a multifunction peripheral configured to execute a plurality of functions including, for example, a copying function, a printing function, a scanning function, and a facsimile function.

The image forming apparatus 1 includes a main body 11, a document reading apparatus 20 opposed to the main body 11 from an upper side, and an intermediate unit 30 interposed between the document reading apparatus 20 and the main body 11.

The document reading apparatus 20 includes an image reading device 5, and a document transport device 6. The document reading device 5 includes a contact glass 161 for placing a source document thereon, fitted in the upper opening of the casing of the document reading device 5. The contact glass 161 includes a fixed document reading section for reading a source document placed thereon, and a moving document reading section for reading a source document being transported by the document transport device 6. The document reading device 5 further includes an openable document holding cover 162 for holding the source document placed on the contact glass 161, and a reading unit 163 that reads the image of the source document placed on the fixed document reading section of the contact glass 161, and also the image of the source document transported to the moving document reading section of the contact glass 161. The reading unit 163 optically reads the image of the source document with an image sensor such as a charge coupled device (CCD) or a complementary metal oxide semiconductor (CMOS), and generates image data representing the source image.

The document transport device 6 includes a document table 61 for placing one or more source documents thereon, a document discharge area 66 to which the source document that has undergone the image reading is discharged, and a document transport mechanism 65. The document transport mechanism 65 includes a feed roller, a transport roller, and a document reversing mechanism. The document transport mechanism 65 picks up the source documents placed on the document table 61 one by one, by driving the feed roller and the transport roller, to transport the source documents to the moving document reading section of the contact glass 161, so that the reading unit 163 may read the source documents. Then the document transport mechanism 65 discharges the source documents to the document discharge area 66. The document transport mechanism 65 also causes the document reversing mechanism to turn the source document face side down and again deliver the source document to the moving document reading section of the contact glass 161, to allow the reading unit 163 to read the images on both sides of the source document.

Further, the document transport device 6 is pivotably mounted on the document reading device 5, so as to allow the front side of the document transport device 6 to be lifted upward. When the upper face of the contact glass 161, serving as a table for the source document, is exposed by lifting up the front side of the document transport device 6, the user can place a source document on the upper face of the contact glass 161.

An operation device 47 is provided on the front side of the document reading apparatus 20. The operation device 47 is used to input user's instructions related to the functions and operations that the image forming apparatus 1 is configured to execute, for example an image forming instruction and a source document reading instruction. The operation device 47 includes a display device 473 for displaying, for example, an operation guide for the user.

The main body 11 includes an image forming device 12, a fixing device 13, a paper feeding device 14, and a sheet discharge section 15.

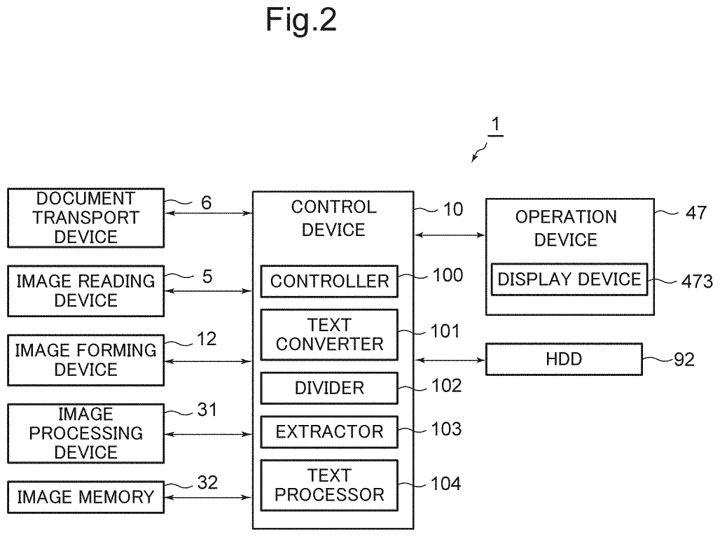

When the image forming apparatus 1 reads a source document, the document reading device 5 optically reads the image of the source document, transported by the document transport device 6 or placed on the contact glass 161, and generates image data. The image data generated by the document reading device 5 is stored in a HDD 92 (see FIG. 2) or a computer connected to a network.

When the image forming apparatus 1 forms an image, the image forming device 12 forms a toner image on a recording sheet P, exemplifying the recording medium, supplied from a paper cassette 145 or a manual bypass tray 141 of the paper feeding device 14, on the basis of the image data generated by the document reading device 5, image data received from a user terminal such as a computer connected to a network or a smartphone, or image data stored in the built-in HDD. The image forming device 12 includes image forming subunits 12M, 12C, 12Y, and 12B, each of which includes a photoconductor drum 121, a developing device that supplies the toner to the photoconductor drum 121, a toner cartridge for storing the toner, a charging device, an exposure device, and a primary transfer roller 126.

The toner images of the respective colors to be transferred onto an intermediate transfer belt 125 are superposed at an adjusted timing, so as to form a colored toner image. A secondary transfer roller 210 transfers the colored toner image formed on the surface of the intermediate transfer belt 125 onto the recording sheet P transported along a transport route 190 from the paper feeding device 14 by a transport roller pair, at a nip region N of a drive roller 125A engaged with the intermediate transfer belt 125. Then the fixing device 13 fixes the toner image onto the recording sheet P by thermal compression. The recording sheet P having the colored image formed and fixed thereon is discharged to an output tray 151.

A configuration of the image forming apparatus 1 will be described hereunder. FIG. 2 is a functional block diagram showing an essential internal configuration of the image forming apparatus 1.

The document reading device 5 includes the reading unit 163 having a light emitter and a CCD sensor. The document reading device 5 is configured to read, under the control of the control device 10, an image from the source document, by irradiating the source document with the light emitter and receiving the reflected light with the CCD sensor.

An image memory 32 includes a region for temporarily storing data to be printed by the image forming device 12. The image memory 32 temporarily stores the document image data acquired through the reading operation of the document reading device 5.

An image processing device 31 retrieves the image read by the document reading device 5 from the image memory 32, and processes the image. For example, the image processing device 31 executes predetermined image processings such as shading correction, to improve the quality of the image formed by the image forming device 12, on the basis of the image read by the document reading device 5.

The image forming device 12 forms images, according to print data read by the document reading device 5, or print data received from a computer connected to a network.

The operation device 47 receives user's instructions related to the functions and operations that the image forming apparatus 1 is configured to execute. The operation device 47 includes the display device 473 having an LCD panel and a touch panel. The touch panel is overlaid on the screen of the display device 473. The touch panel is based on a resistive film or electrostatic capacitance, and configured to detect a contact (touch) of the user's finger, along with the touched position, and outputs a detection signal indicating the coordinate of the touched position, to the controller 100.

A hard disk drive (HDD) 92 is a large-capacity storage device for storing, for example, the source images read by the document reading device 5.

The control device 10 includes a processor, a random-access memory (RAM), a read-only memory (ROM), and an exclusive hardware circuit. The processor is, for example, a central processing device (CPU), a micro processing device (MPU), or an application specific integrated circuit (ASIC). The HDD 92 or the ROM contains a data processing program, so that the control device 10 acts as a controller 100, a text converter 101, a divider 102, an extractor 103, and a text processor 104, by operating according to the data processing program. Alternatively, the control device 10 may include the controller 100, the text converter 101, the divider 102, the extractor 103, and the text processor 104 in the form of hardware circuits, instead of operating according to the data processing program.

The controller 100 serves to control the overall operation of the image forming apparatus 1. The controller 100 is connected to the image reading device 5, the document transport device 6, the image memory 32, the image processing device 31, the image forming device 12, the operation device 47, and the HDD 92, and controls the operation of the mentioned components. The controller 100 also executes the data processing as will be subsequently described. Further, the controller 100 controls the displaying operation of the display device 473. The controller 100 controls the display device 473 so as to display a screen required for executing the data processing.

The text converter 101 converts the source image acquired by the image reading device 5 through the reading of the source document into text data, by a known OCR technique.

The divider 102 divides the text data converted by the text converter 101 into a plurality of text groups, using a predetermined criterion. An example of the predetermined criterion adopted by the divider 102 includes regarding a section from a text written in a specific font, to a text immediately before another text of the specific font that appears next, as one text group. The specific font may be, for example, a capital alphabet. In this embodiment, it will be assumed that the capital alphabet is adopted as the specific font.

The predetermined criterion adopted by the divider 102 further includes keeping from regarding as one text group, despite another text of the specific font having appeared following the preceding text of the specific font, provided that a predetermined numbering is given to the text of the specific font that has appeared, until still another text of the specific font without the numbering appears. Here, examples of the predetermined numbering include numerical consecutive numbering such as “1.”, “2.”, and “3.”, and alphabetical consecutive numbering such as “A.”, “B.”, and “C.”.

The divider 102 may also regard a section up to a position where a period “.” appears as one sentence (text group), as another example of the predetermined criterion. Alternatively, although the period has not appeared, when a space larger than a predetermined size is inserted between the texts (characters), the divider 102 may decide that a sentence finishes at the position immediately before such space, and that a new sentence begins from the position immediately after the space, and regard the section up to the space as one text group.

The extractor 103 extracts, from the plurality of text groups divided by the divider 102, a key text group containing the specific word identified by a predetermined rule, among the words contained in the text data constituting the plurality of text groups. The predetermined rule adopted by the extractor 103 includes designating a word that appears first, or appears most frequently, among the words contained in the text data, as the specific word.

The text processor 104 creates processed text data by placing the key text group extracted by the extractor 103 at the head position, and placing the remaining text groups other than the key text group, in the plurality of text groups divided by the divider 102, at the position subsequent to the key text group.

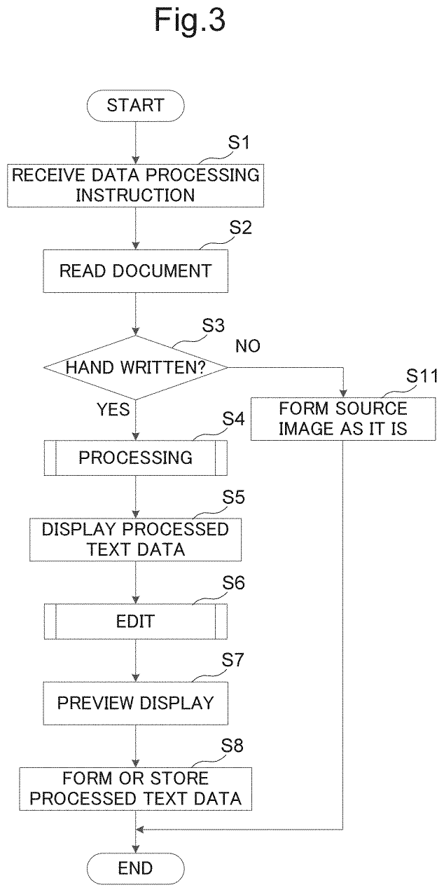

Hereunder, data processing performed by the image forming apparatus 1 will be described. FIG. 3 is a flowchart showing the data processing performed by the image forming apparatus 1. Referring to FIG. 3, an outline of the data processing will be described.

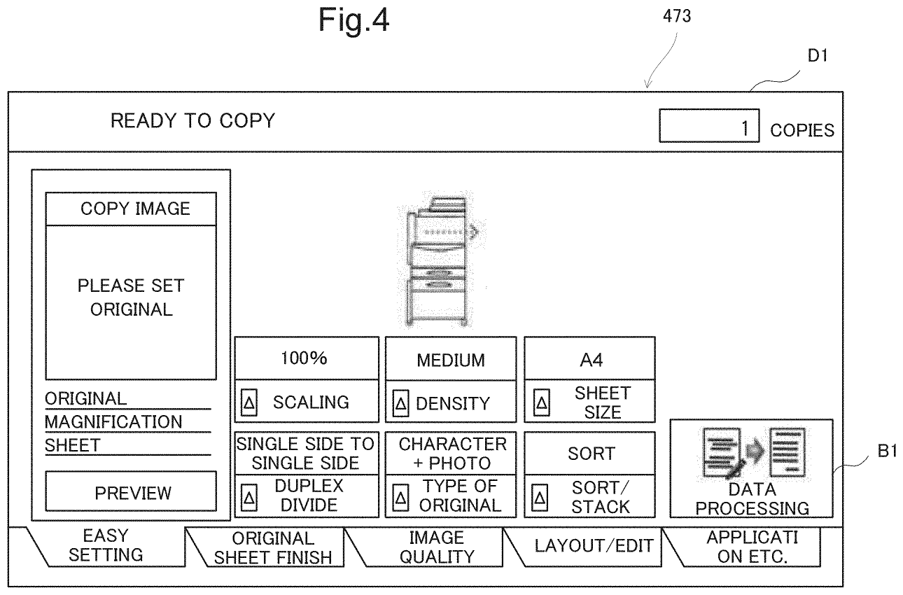

Before the user inputs an instruction to perform the data processing, in other words in a standby state for the input of the instruction, the controller 100 causes the display device 473 to display an operation screen D1 shown in FIG. 4. The operation screen D1 includes an instruction button B1, for the user to input the instruction to perform the data processing.

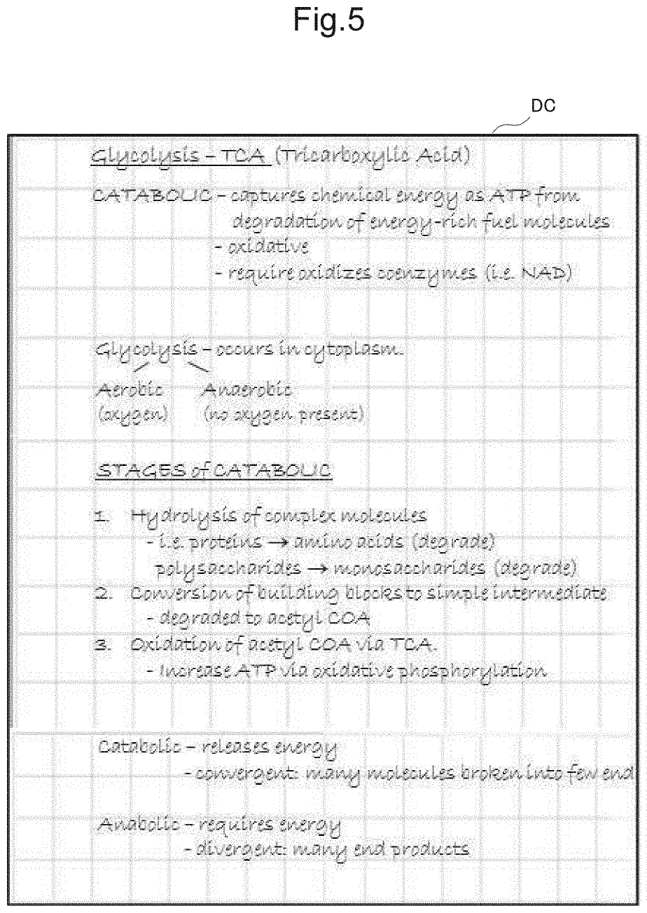

It is assumed here that the user has made up a hand-written source document DC, containing hand-written characters as shown in FIG. 5. The user places the hand-written source document DC on the document table 61 or the contact glass 161 of the image reading device 5.

Thereafter, when the user touches the instruction button B1 on the operation screen D1 displayed on the display device 473, the instruction to perform the data processing is inputted to the operation device 47 through the touch panel, and the controller 100 receives the instruction to perform the data processing (step S1). The controller 100 causes the image reading device 5 to read the hand-written source document DC, according to the instruction to perform the data processing (step S2). Then the controller 100 decides, with a known technique, whether the source document that has been read is a hand-written source document, on the basis of the source image acquired by the image reading device 5 through the reading of the hand-written source document DC (step S3).

When the source document that has been read is decided not to be a hand-written source document (NO at step S3), the controller 100 causes the image forming device 12 to form the source image acquired from the source document, on the recording sheet P (step S11).

In contrast, when the controller 100 decides that the source document that has been read is a hand-written source document (YES at step S3), the text converter 101, the divider 102, the extractor 103, and the text processor 104 perform the processing on the source image (step S4).

When the processed text data based on the source image is created through the processing, the controller 100 causes the display device 473 to display the processed text data (step S5). To realize this display, the text processor 104 receives an editing instruction from the user through the touch panel, and performs an editing operation including converting the text group designated by the editing instruction into a font designated by the editing instruction, or moving the text group designated by the editing instruction to a position designated by the editing instruction (step S6).

After the mentioned editing operation, the controller 100 causes the display device 473 to display the preview of the processed text data that has been edited (step S7). Then the controller 100 either (i) causes the image forming device 12 to form the image of the processed text data that has been edited, on the recording sheet P, or (ii) stores the processed text data in the HDD 92 (step S8).

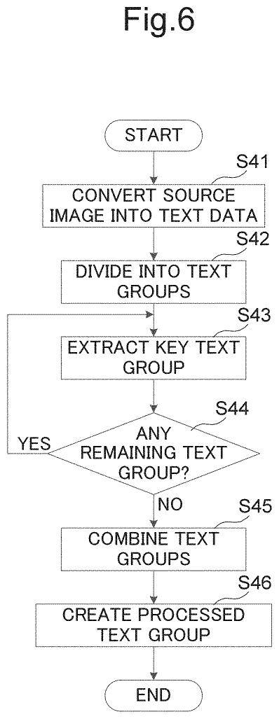

Hereunder, the processing at step S4, which is a part of the data processing operation, will be described in further detail. FIG. 6 is a flowchart showing the text processing operation.

When the processing is performed at step S4, first the text converter 101 converts the source image acquired by reading the source document into text data (step S41). Then the divider 102 divides the converted text data into a plurality of text groups, according to the predetermined criterion (step S42).

At this point, the divider 102 either (i) designates capital alphabets as the specific font, and regards a section from a text containing a capital alphabet, to a text immediately before the next text containing a capital alphabet, as one text group, or (ii) regards a section from a text constituted of capital alphabets, which are the specific font, or from a text that begins at the position immediately after a period “.”, to the next period “.”, as one text group, according to the predetermined criterion.

However, the divider 102 keeps from regarding as one text group, despite another text of the specific font having appeared following the preceding text of the capital alphabet, which is the specific font, provided that a predetermined consecutive numbering, such as “1.”, “2.”, and “3.”, is given to the text of the specific font that has appeared, until still another text of the specific font without the numbering appears, or until a period “.” appears.

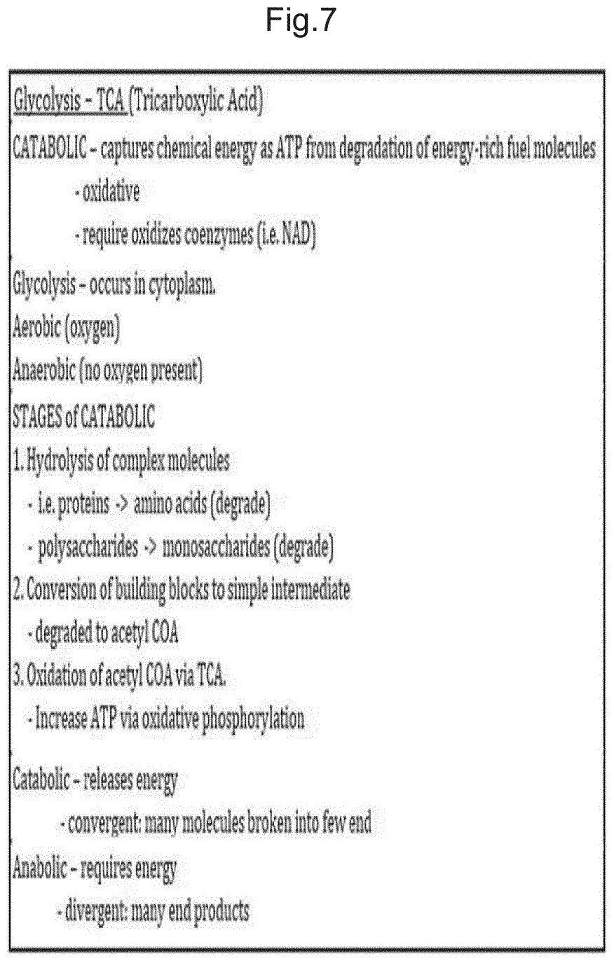

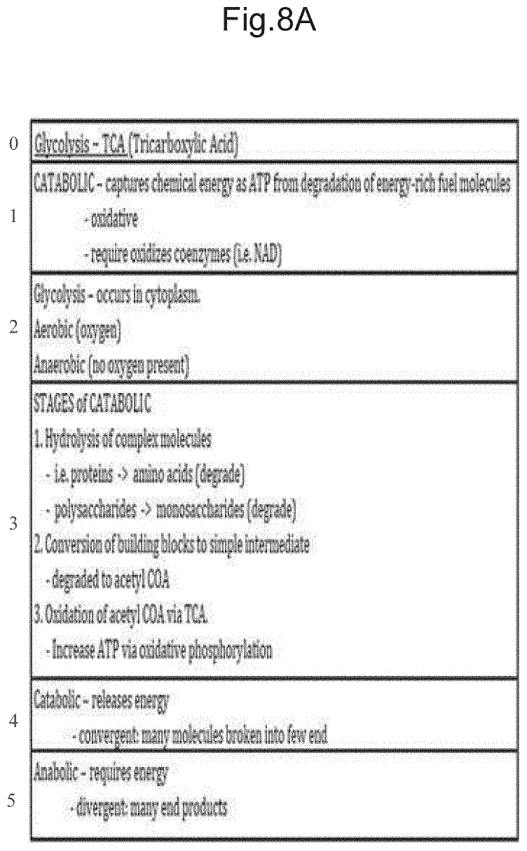

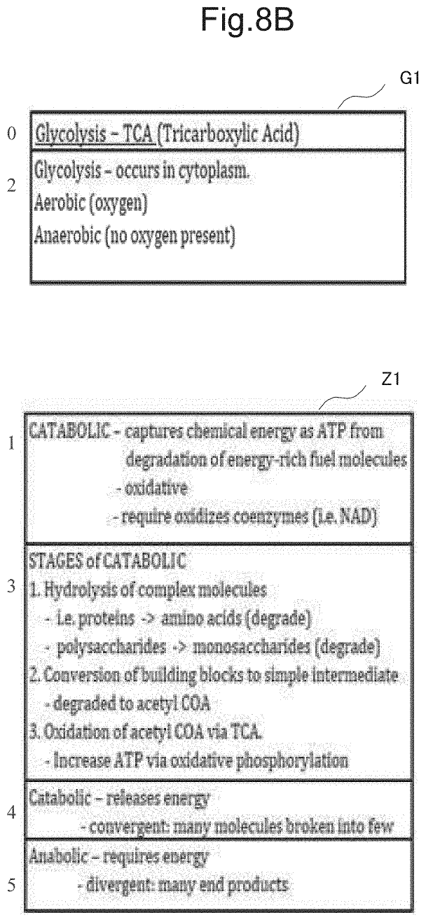

As result of the dividing operation of the divider 102, the text data converted by the text converter 101 (FIG. 7) is divided into text groups 0 to 5, as shown in FIG. 8A.

Then the extractor 103 extracts as a key text group, from the plurality of text groups divided by the divider 102, one or a plurality of text groups containing the specific word identified by a predetermined rule, among the words contained in the text data constituting the plurality of text groups (step S43). In this example, the extractor 103 extracts a word that appears first among the words contained in the text data, as the specific word, according to the predetermined rule.

After the mentioned extraction by the extractor 103, the text processor 104 places the key text group at the head, and decides whether any remaining text groups other than the key text group are present in the plurality of text groups divided by the divider 102 (step S44).

When the text processor 104 decides that one or more remaining text groups are present (YES at step S44), the extractor 103 extracts a new key text group, containing a new specific word identified by the predetermined rule, out of the words contained in the text data constituting the remaining text groups (step S43).

After the additional extraction by the extractor 103, the text processor 104 places the new key text group at the position subsequent to the key text group placed earlier at the head, and decides whether any text groups are left, without being designated as the new key text group (step S44).

The extractor 103 and the text processor 104 repeat the operation of step S43 and step S44, until the remaining text group is no longer present, or until the extractor 103 can no longer extract a text group (NO at step S44). The text processor 104 combines the text groups thus far placed (step S45), when no remaining text group is present, or when the extractor 103 becomes unable to extract a text group (NO at step S44).

Thus, each time a new remaining text group is found, the extractor 103 extracts a new key text group, and the text processor 104 creates the processed text data.

For example, when remaining text groups are present after the extraction by the extractor 103, the text processor 104 places a key text group G1 (text groups 0 and 2 extracted using “glycolysis” as the specific word) at the head, and places a remaining text group Z1 (text groups 1, 3, 4, and 5) next to the key text group G1, as shown in FIG. 8B. Then the extractor 103 further extracts a new key text group G2 (text groups 1, 4, and 3) out of the remaining text group Z1, using “catabolic” as a new specific word, as shown in FIG. 8C. FIG. 8C illustrates an example where a new text group Z2 (text group 5), remaining after the mentioned extraction, only includes one text group, and therefore the extractor 103 can no longer extract a text group.

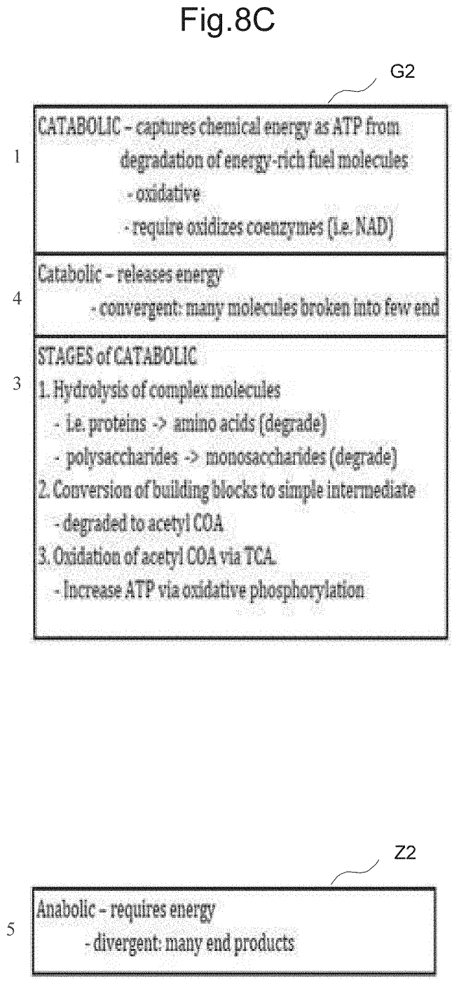

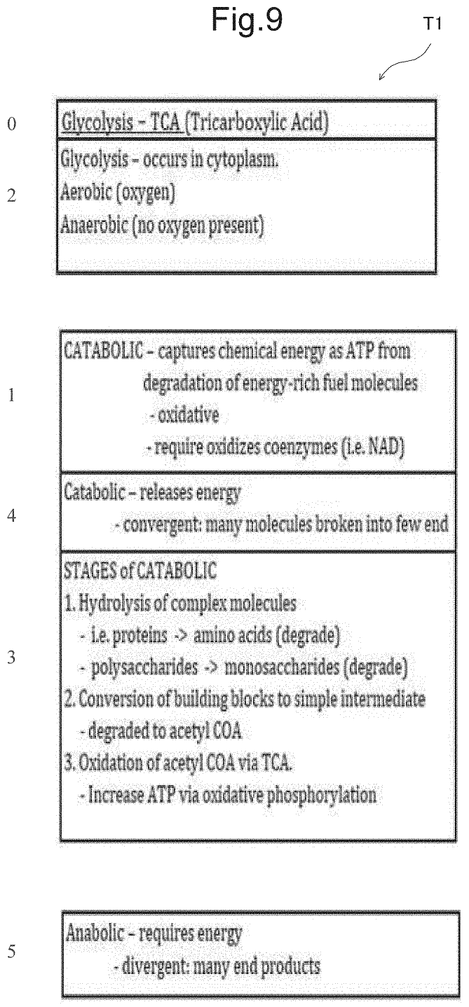

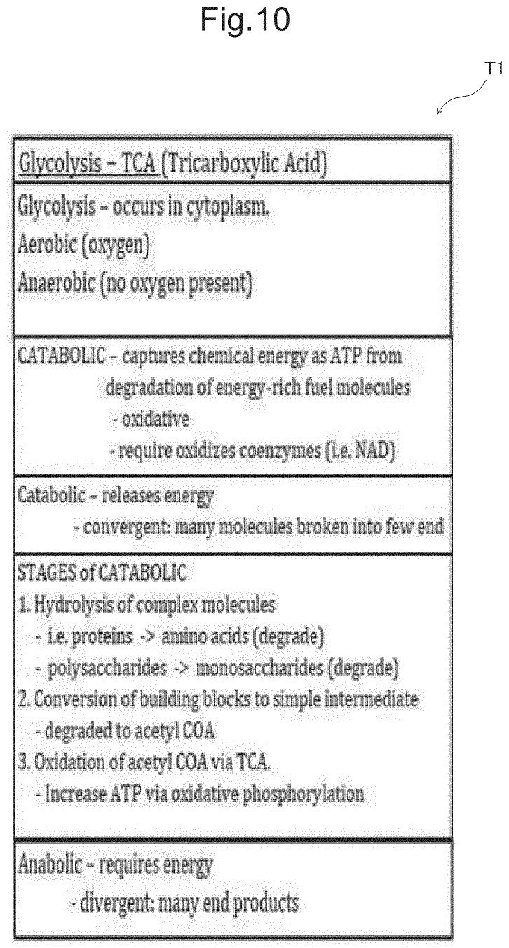

After step S45, text data T1 arranged as the example shown in FIG. 9 is obtained, and the text processor 104 combines those text groups as shown in FIG. 10, thereby creating processed text data GT as the example shown in FIG. 11 (step S46).

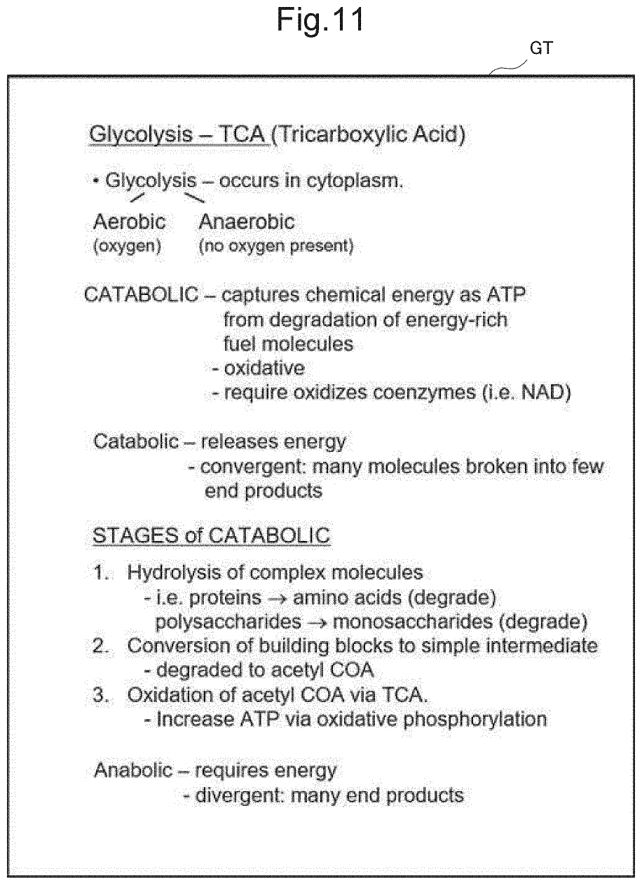

Hereunder, the editing operation at step S6, which is also a part of the data processing operation, will be described in further detail. FIG. 12 is a flowchart showing the editing operation.

Before the editing operation is performed at step S6, the text processor 104 stands by for an input of the editing instruction through the touch panel, while the processed text data is displayed on the display device 473 under the control of the controller 100 (NO at step S61). When the editing instruction is inputted through the touch panel (YES at step S61), the text processor 104 analyzes the editing instruction (step S62).

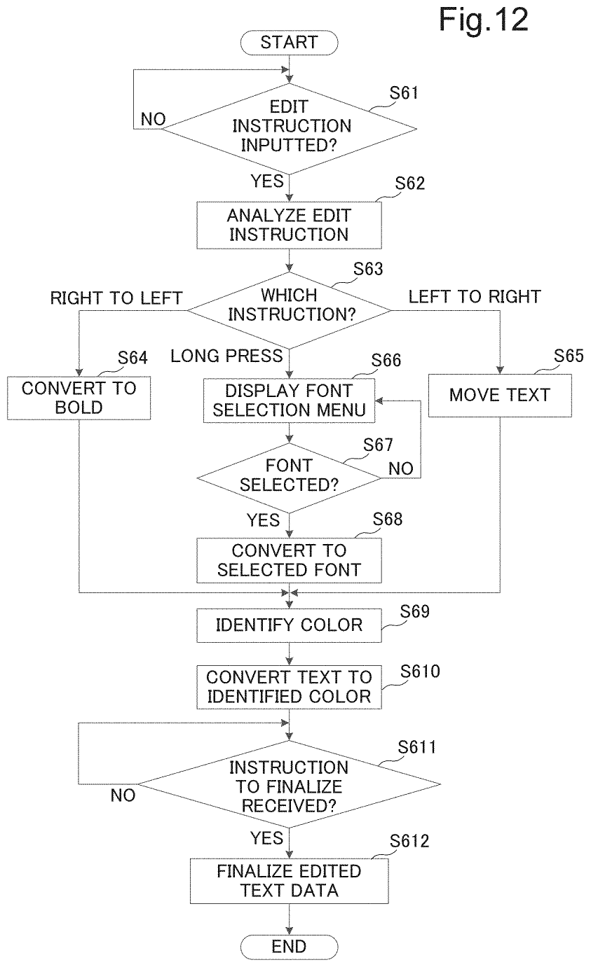

When the editing instruction is a slide operation from right to left on the screen as the example shown in FIG. 13 (“Right to Left” at step S63), the text processor 104 recognizes text data T2, written in one line and displayed at the position where the slide operation has been performed, as the title, and converts the text data of one line into a predetermined font assigned to the title, in this example a bold font (step S64).

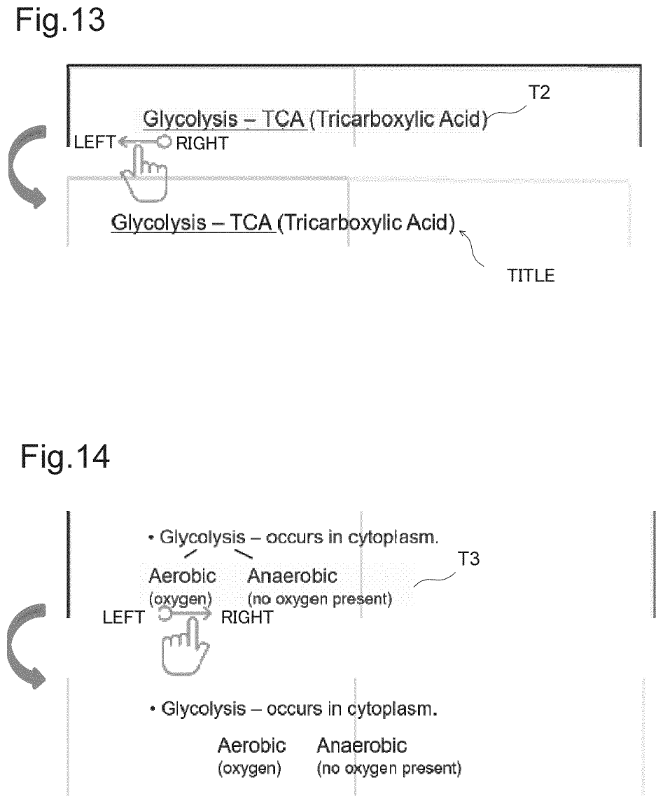

In addition, when the editing instruction is a slide operation from left to right on the screen as the example shown in FIG. 14 (“Left to Right” at step S63), the text processor 104 moves text data T3 written in one line and displayed at the position where the slide operation has been performed, to a position shifted by a distance corresponding to the sliding action, in the direction of the sliding action (step S65). It is to be noted here that, in FIG. 14, a text “Aerobic” is accompanied with a ruby “(oxygen)” and a text “Anaerobic” is accompanied with a ruby “(no oxygen present)”, and therefore the text and the ruby are collectively regarded as one line.

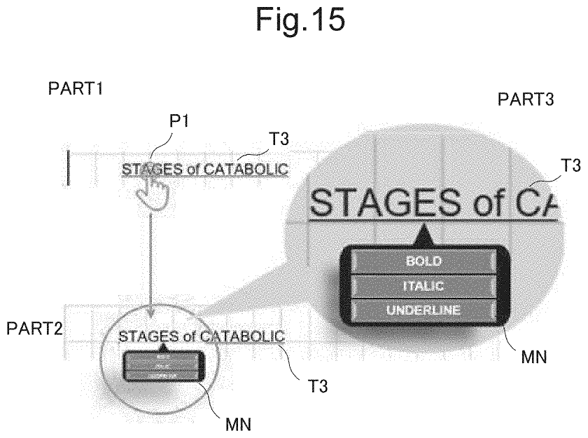

When the editing instruction is a long press on a point P1 on the screen, as the example shown in Part 1 of FIG. 15 (“Long Press” at step S63), the controller 100 causes the display device 473 to display a font selection menu MN at the point P1 on the screen, as the example shown in Part 2 of FIG. 15 (step S66). Here, Part3 of FIG. 15 represents an enlarged view of Part 2 of FIG. 15. When the user selects a desired font by touching the position on the font selection menu MN where the desired font is shown (YES at step S67), the text processor 104 applies the selected font, either bold font or italic font, or applies an underline, to the text data T3 in one line, displayed at the position where the long press has been performed (step S68).

Further, the text processor 104 identifies in which color each of the texts generated by the text conversion is written (step S69), for example on the basis of the pixel value of the pixels constituting the source image acquired by reading the source document at step S2 (FIG. 3). The text processor 104 then converts the color of each text to the identified color (step S610).

Thereafter, the text processor 104 stands by for a user's input of an instruction to finalize the editing operation through the operation device 47 (NO at step S611), and finally fixes the processed and edited text data (step S612), when the user inputs the instruction to finalize the editing operation through the operation device 47 (YES at step S611).

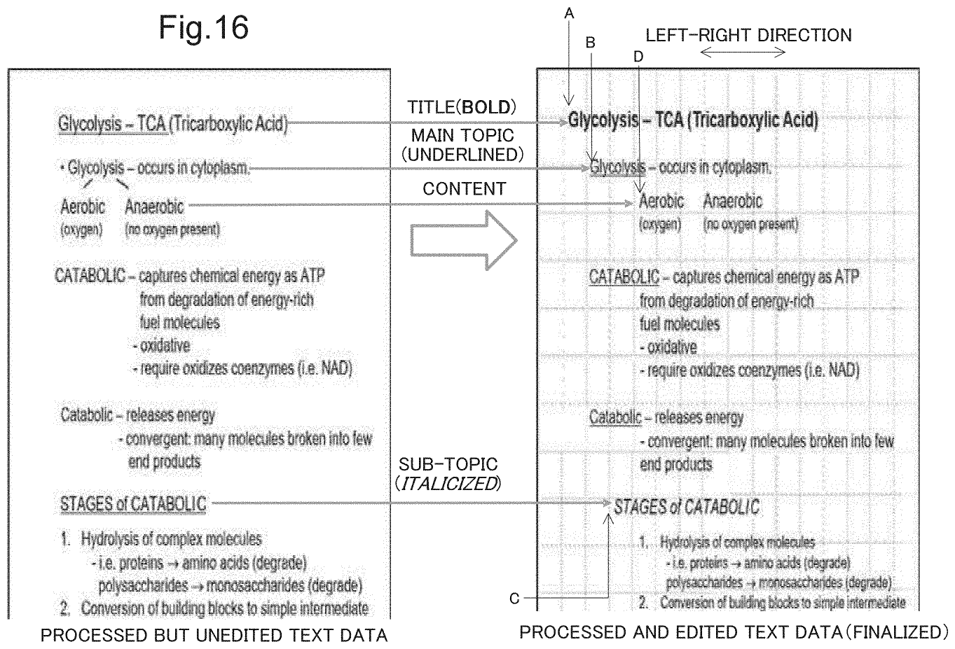

At this point, the text data that has undergone the data processing and the editing operation is completed, as shown in FIG. 16. FIG. 16 illustrates an example of the text data finalized after the editing operation, in which a text “Glycolysis-TCA (Tricarboxylic Acid)” is expressed in the bold font, a word “Glycolysis” in a text “Glycolysis-occurs in cytoplasm.” is underlined, and a text “STAGES of CATABOLIC” is expressed in the italic font.

Here, the text processor 104 may perform the following operation, instead of the operation according to step S63 to step S68. For example, when the editing instruction analyzed at step S62 is a slide operation from right to left or from left to right on the screen, the text processor 104 may move text data written in one line and displayed at the position where the slide operation has been performed, to a position shifted by a distance corresponding to the sliding action, in the direction of the sliding action. Then the text processor 104 may recognize the category of the text data as one of title, main topic, sub topic, and content, according to the position to which the text data has been moved, and convert the text data of one line to a predetermined font assigned to the recognized category.

Referring to FIG. 16, for example a position A in the left-right direction of the screen may be registered as the position associated with the title, a position B as the position associated with the main topic, a position C as the position associated with the sub topic, and a position D as the position associated with the content, in the text processor 104, so that, when the text data is placed at one of the positions A to D, the text processor 104 may recognize the category corresponding to the position where the text data is placed, as the category of the text data.

Then the text processor 104 may convert the font, for example by converting to the bold font when the text data is recognized as the title, applying the underline when the text data is recognized as the main topic, converting to the italic font when the text data is recognized as the sub topic, and keeping the font unchanged when the text data is recognized as the content. Such an arrangement allows, as shown in FIG. 16, each of the text data, instructed to undergo the editing operation, to be moved to a desired position, and also to be subjected to the font conversion, thereby further facilitating the user to perform the editing operation.

Now, with the foregoing background art, the text data in which the order of sentences is changed is unable to be created, on the basis of the content described in the source document. With the background art, when the user wishes to change the order of the sentences depending on the content of the source document, the user has to understand the content of the source document, and then edit the data converted into text, by using an application such as a word processor.

With the arrangement according to this embodiment, in contrast, the text data in which the order of sentences is changed can be created, on the basis of the content of the source document, without the need to make the user perform the editing operation. The user can be exempted from performing the editing operation, when the purpose is only creating the text data in which the order of sentences is changed, on the basis of the content of the source document.

Further, the user can change the position and the display format of the text data as desired, simply by inputting the processing instruction or the editing instruction, when the preview is displayed on the display device 473.

The disclosure is not limited to the foregoing embodiment, but may be modified in various manners. The configurations and processings described in the foregoing embodiments with reference to FIG. 1 to FIG. 16 are merely exemplary, and in no way intended to limit the disclosure to those configurations and processings.

While the present disclosure has been described in detail with reference to the embodiments thereof, it would be apparent to those skilled in the art the various changes and modifications may be made therein within the scope defined by the appended claims.

What is claimed is:

1. An information processing apparatus comprising:
an image reading device that reads an image of a source document; and
a control device including a processor, and configured to act, when the processor executes a control program, as:
a text converter that converts a source image acquired by the image reading device through reading of the source document, into text data;
a divider that divides the text data converted by the text converter into a plurality of text groups, using a predetermined criterion;
an extractor that extracts, from the plurality of text groups divided by the divider, a key text group containing a specific word identified by a predetermined rule, among words contained in the text data constituting the plurality of text groups; and
a text processor that creates processed text data by placing the key text group at a head position, and placing remaining text groups other than the key text group in the plurality of text groups, at a position subsequent to the key text group.

2. The information processing apparatus according to claim 1,
wherein the extractor further extracts, from the remaining text groups, a new key text group containing a new specific word identified by the rule among words contained in the text data constituting the remaining text groups, and
the text processor creates the processed text data, by placing the new key text group at a position subsequent to the key text group extracted earlier, and placing text groups other than the new key text group in the remaining text groups, at a position subsequent to the new key text group, as a new remaining text groups.

3. The information processing apparatus according to claim 2,
wherein, each time the new remaining text groups are created, the extractor extracts the new key text group, and the text processor creates the processed text data.

4. The information processing apparatus according to claim 1,
wherein the divider adopts a criterion, as the predetermined criterion, including regarding a section from a text written in a specific font, to a text immediately before another text written in the specific font that appears next, as one text group.

5. The information processing apparatus according to claim 4,
wherein, as an operation according to the predetermined criterion, the divider keeps from regarding as one text group, despite another text of the specific font having appeared following the preceding text of the specific font, provided that a predetermined numbering is given to the another text of the specific font that has appeared, until still another text of the specific font without the numbering appears.

6. The information processing apparatus according to claim 1,
wherein the extractor adopts the rule including designating a word that appears first, or appears most frequently, among the words contained in the text data, as the specific word.

7. The information processing apparatus according to claim 1, further comprising:
a display device; and
a touch panel provided on the display device, and through which an instruction of a user is inputted, according to a touch of the user on a screen of the display device,
wherein the control device further acts as a controller that causes the display device to display the processed text data, and
the text processor converts a text group designated by an instruction inputted through the touch panel, while the processed text data is displayed on the display device by the controller, into a predetermined font.

8. The information processing apparatus according to claim 7,
wherein the text processor moves the text group designated by the instruction inputted through the touch panel, while the processed text data is displayed on the display device by the controller, to a position designated by the instruction.

9. The information processing apparatus according to claim 8, wherein the text processor converts the moved text data into a predetermined font, according to a position to which the text data has been moved.

10. An image forming apparatus comprising:
the information processing apparatus according to claim 1; and
an image forming device that forms an image representing the processed text data on a recording medium.
